(19) United States
(12) Patent Application Publication
(10) Pub. No.: US 2020/0386310 A1
(43) Pub. Date: Dec. 10, 2020

(54) ACTUATION DEVICE FOR ACTUATING AN EMERGENCY RELEASE OF THE TRANSMISSION OF A MOTOR VEHICLE, IN PARTICULAR OF A CAR

(71) Applicant: AUDI AG, Ingolstadt (DE)

(72) Inventors: Georg SCHEIBLECKER, Kipfenberg-Böhming (DE); Bodo WILKE, Hitzhofen (DE); Maximilian STEFFAN, Manching (DE); Iris SZOKA, Hitzhofen (DE)

(73) Assignee: AUDI AG, Ingolstadt (DE)

(21) Appl. No.: 16/767,375

(22) PCT Filed: Nov. 22, 2018
(86) PCT No.: PCT/EP2018/082290

§ 371 Date: May 27, 2020

(30) Foreign Application Priority Data
Nov. 27, 2017 (DE) 10 2017 221 197.0

(51) Int. Cl. F16H 63/34; B60K 20/02

(52) U.S. Cl. CPC F16H 63/3491; B60K 20/02

(57) ABSTRACT

An actuating device for actuating an emergency release of a transmission of a motor vehicle, which transmission includes a parking lock and is mechanically blocked by the parking lock when the parking lock is activated, said actuating device having at least one vehicle-fixed actuating element, by which the parking lock can be deactivated manually and mechanically, and having a tool configured as separate from the actuating element, via which the actuating element can be manually and mechanically actuated to manually deactivate the parking lock, wherein the tool includes at least one lever, which is held pivotably on a component that can be located in the passenger compartment of the motor vehicle, and which can be pivoted relative to the component into at least one actuation position to actuate the actuating element.

The invention relates to an actuating device for actuating an emergency release of a transmission of a motor vehicle, in particular of a car, according to the preamble of claim 1.

An actuating device of this type for actuating an emergency release of a transmission, which comprises a parking lock, of a motor vehicle, in particular of a car, is known, for example, from DE 10 2011 119 747 A1. The transmission can be configured as an automatic transmission and, when the parking lock is activated, is mechanically blocked by means of the parking lock. This is understood to mean, in particular, that, for example, a transmission output shaft of the transmission is secured against rotation relative to a housing of the transmission. The motor vehicle can thereby be secured against rolling away unintentionally, for example, in particular if the motor vehicle is stopped and/or parked on a slope.

The actuating device comprises at least one vehicle-fixed actuating element, by means of which the parking lock can be deactivated manually and thus, for example, by a person. The actuating device further comprises a tool that is configured as separate from the actuating element, via which the actuating element can be actuated manually and mechanically to manually deactivate the parking lock. The tool is initially spaced from the actuating element, for example, and can in particular be moved relative to the actuating element so as to bring the tool into cooperation with the actuating element. This enables the actuating element to be actuated manually by said person via the tool, for example, whereby the person can manually deactivate the parking lock.

In addition, DE 102 41 877 A1 discloses a driving speed selection device for an automatic transmission of a motor vehicle, which is equipped with a positioning element, a drive element, a further drive element, at least one actuating lever, and an emergency actuating device.

Furthermore, DE 10 2009 019 812 A1 discloses a vehicle having a transmission, which can assume various driving states, a neutral state, and a parking state, since in the parking state the transmission is locked by a locking element. A manually actuable emergency release device is additionally provided, by the actuation of which the transmission can be unlocked in the event of a malfunction. The object of the present invention is to provide an actuating device, so that a transmission of a motor vehicle can be particularly easily unlocked manually and mechanically.

This object is attained according to the invention by an actuating device having the features of 1. Advantageous embodiments with expedient refinements of the invention are specified in the remaining claims.

The invention relates to an actuating device for actuating an emergency release of a transmission of a motor vehicle, in particular of a car, and in this case preferably of an automobile. The transmission is configured, for example, as an automatic transmission, in particular as a torque-converter automatic transmission, and includes a parking lock. When the parking lock is activated, the transmission is blocked mechanically by means of the parking lock. The motor vehicle can thereby be secured against rolling away unintentionally, for example, in particular if the motor vehicle is stopped and/or parked on a slope.

The transmission can ordinarily be actuated via shift-by-wire, so that the parking lock, in particular, can at least be disengaged or deactivated via shift-by-wire. This is understood, in particular, to mean that an actuator, in particular an electrically operable actuator, is typically provided, and the parking lock can at least be deactivated by means of the actuator. If a signal, in particular an electrical signal, for deactivating the parking lock is detected, for example, the parking lock is thus deactivated by means of the actuator. However, if a malfunction occurs, in particular a power failure, so that the parking lock can no longer be deactivated electrically by means of the actuator, the parking lock can thus be deactivated manually and mechanically by means of the emergency transmission release. This enables the motor vehicle to be moved even with the malfunction and, for example, towed away without damage occurring. The emergency transmission release is part of the actuator, or vice versa, for example, and therefore, the parking lock can be deactivated, for example, via the actuator by means of the emergency transmission release.

The actuating device in this case comprises at least one vehicle-fixed actuating element, which is held on the motor vehicle and is thus a permanent part of the motor vehicle. By means of the actuating element, the parking lock can be deactivated manually and in particular mechanically, for example by a person. The actuating device further comprises a tool that is configured as separate from the actuating element, and via which the actuating element can be actuated manually and mechanically to manually deactivate the parking lock. The feature that the tool is configured as separate from the actuating element is understood, in particular, to mean that the tool and the actuating element are two components configured as separate from one another and thus as respective components that are not configured as integral with one another, for example. In a home state, for example, the actuating element is spaced apart from the tool, or vice versa, and the tool can be brought and/or moved into cooperation with the actuating element, for example, to thus manually and mechanically actuate the actuating element via the tool, and thereby deactivate the parking lock.

To enable the parking lock to then be manually and mechanically deactivated in a particularly simple manner, it is provided according to the invention that the tool comprises at least one lever, which is held pivotably on a component that is or can be arranged in the passenger compartment of the motor vehicle, and which can be pivoted relative to the component, in particular from the home position of said lever to at least one actuation position, for the purpose of actuating the actuating element. Use of the lever enables a particularly advantageous gear ratio, in particular lever ratio, to be realized, so that the actuating element can easily be actuated manually, for example by a person. In other words, particularly advantageous lever ratios can be produced, so that, for example, the person needs to exert only a low level of force on the lever in order to actuate the actuating element via the lever, and thereby deactivate the parking lock. Since the lever is held pivotably on the component, which can be located in the passenger compartment of the motor vehicle or which is located in the passenger compartment thereof when production of the motor vehicle is fully complete, the parking lock can be deactivated and in particular kept deactivated particularly easily and conveniently from the passenger compartment of the motor vehicle, in particular manually by a person.

This means that when production of the motor vehicle is fully complete, the component is located in the passenger compartment of the motor vehicle. Since the lever is held on the component, the lever can be pivoted into the actuation position relative to the component by a person in the passenger compartment of the motor vehicle, thereby allowing the parking lock to be deactivated or released from the passenger compartment. It is conceivable, in particular, for the lever to be pivotable from the driver's seat, so that the parking lock can be deactivated, and in particular kept deactivated, by a person sitting in the driver's seat. In this way it is possible, for example, for the person to keep the parking lock deactivated, while at the same time actuating a brake and/or a steering wheel of the motor vehicle, so that, for example, the motor vehicle can be maneuvered safely and in the manner required.

It has proven advantageous for the lever to be held on the component such that the lever is pivotable about a pivot axis relative to the component. This means that the lever can be pivoted about the pivot axis relative to the component while the lever is held on the component. Thus the person can deactivate the parking lever particularly easily and conveniently via the lever.

It has proven particularly advantageous for the pivot axis to extend in the vehicle vertical direction when the actuating device and the component are in the installed position. Since the tool and thus the lever are component parts of the actuating device, and since the lever is held pivotably on the component, the component is also a part of the actuating device, for example. Thus, when the actuating device assumes its installed position, for example, the component also assumes its installed position at the same time, and vice versa. The actuating device or the component assumes its installed position when production of the motor vehicle is fully complete, i.e., in particular when the component or the actuating device has been installed in or on the motor vehicle. Since the pivot axis preferably extends in the vehicle vertical direction when the actuating device is in its installed position, the lever can be pivoted particularly easily by a person in the passenger compartment of the motor vehicle, thereby enabling the parking lock to be deactivated particularly easily.

To enable the parking lock to be deactivated particularly easily, it is provided in a further embodiment of the invention that the lever has a first longitudinal region and a second longitudinal region, adjoining the first longitudinal region in the longitudinal direction of extension of the lever, the pivot axis being situated between the longitudinal regions in the longitudinal direction of extension of the lever. In this way, advantageous gear ratios or lever ratios can be realized, in particular, so that the actuating element can be deactivated manually and mechanically by exerting only a low level of force on the lever.

To enable the lever to be pivoted particularly easily, in particular, from the home position to the actuation position, it is provided in a further embodiment of the invention that the component has a recess that is associated with the second longitudinal region, in which recess the second longitudinal region is at least partially disposed when the lever, which is pivotable from a home position to the actuation position, is in the home position. In this way, the person can, from the passenger compartment of the motor vehicle for example, first exert a force, in particular a pressing force, on one of the longitudinal regions, in particular on the second longitudinal region, thereby first pivoting the lever, for example, easily about the pivot axis relative to the component, from the home position to an intermediate position. The other longitudinal region, in particular the first longitudinal region, is thereby moved, for example, in particular pivoted, out of a socket, recess, or opening, in particular of the component. The person can then grip or grasp the other longitudinal region, in particular the first longitudinal region, with his/her hand, for example, allowing the person to pivot the lever particularly easily from the intermediate position to the actuation position. Thus, the actuating element can be actuated particularly easily, and therefore, the parking lock can be particularly easily deactivated.

For this purpose, the actuating element is connected, for example, to one of the longitudinal regions, in particular to the first longitudinal region, so that, for example by moving the lever from the starting position to the actuation position, the actuating element is moved at least partially along with the lever. By moving the lever into the actuation position, the actuating element is moved in such a way, in particular, that the deactivation of the parking lock results.

To enable the lever to be pivoted particularly easily, in particular into the intermediate position, it is preferably provided that when the actuating device and the component are in the installed position, the recess is open toward the passenger compartment of the motor vehicle, and more particularly is open toward the rear in the vehicle longitudinal direction. Thus, when the lever is initially in the home position, for example, the person in the passenger compartment of the vehicle can press in the recess with one finger, and thereby exert a pressing force on the second longitudinal region. The lever is thereby moved from the home position to the intermediate position, whereupon the lever can be pivoted particularly easily from the intermediate position to the actuation position. Thus, a particularly easy and convenient actuation of the lever and thus of the actuating element is presented.

A further embodiment is characterized in that the component comprises a through opening, wherein the lever and/or the actuating element penetrates the through opening, at least when the lever is in the actuation position. The through opening is thus formed in the component that is or can be arranged in the passenger compartment of the motor vehicle. The through opening in this case has a passage direction, for example, which, in particular when the component or the actuating device is in the installed position, can extend within a plane spanned by the vehicle transverse direction and the vehicle vertical direction, or within a plane spanned by the vehicle transverse direction in the vehicle longitudinal direction. The passage direction of the through opening is a direction along which a fluid, such as gas or air, for example, or a narrow object can or might be pushed through the through opening. In particular, the through opening extends at least substantially perpendicular, for example, to a through plane in which the through opening extends. The through plane is spanned, for example, by the vehicle transverse direction in the vehicle vertical direction or by the vehicle longitudinal direction through the vehicle vertical direction. Along the passage direction, the through opening can be or is penetrated by the lever and/or by the actuating element, at least in the actuation position. In other words, the actuating element and/or the lever penetrates the through opening at least in a state in which the parking lock is being deactivated or is deactivated by means of the lever, along the passage direction.

Use of the through opening enables a path of sufficient size to be realized, by which the lever, and with it the actuating element, can be moved, thereby enabling the parking lock to be easily and conveniently deactivated. In particular, this makes it possible to release the parking lock from the passenger compartment of the motor vehicle, and in particular from the driver's seat, so that the parking lock can be deactivated particularly conveniently and easily by a person in the passenger compartment.

In the installed position, or when the motor vehicle is in the fully produced state, the through opening opens, for example, on one side or at one end, into the passenger compartment of the car, so that, for example, a person in the passenger compartment can actuate the tool or the lever from the passenger compartment, in order to deactivate the parking lock from the passenger compartment. On the other side or at the other end, the through opening leads, for example, into a region located outside of the passenger compartment, and thus on a side of the component that faces away from the passenger compartment, wherein in said region, for example, the actuating element or the transmission is located in particular at least in the home position, for example. Thus, at least in the actuation position, for example, the actuating element or the lever can extend along the passage direction from the passenger compartment, through the through opening, and into said region, so that the parking lock can be deactivated from the passenger compartment. In this way, the parking lock can be deactivated manually and mechanically particularly easily, thereby releasing the transmission.

When the actuating device is in the installed position, the passage direction extends, for example, in the vehicle transverse direction or in the vehicle longitudinal direction, thereby enabling the parking lock to be deactivated particularly easily and conveniently. Since the lever is held on the component, the lever or the tool is configured as a tool fixed to the vehicle, in which case the lever is held at least indirectly, in particular directly, on the component and is pivotable relative thereto.

In a particularly advantageous embodiment of the invention, when the actuating device and thus the component is in the installed position, the through opening points toward the rear in the vehicle longitudinal direction. This enables the actuating element to be actuated particularly advantageously, for example, since when the lever is in the actuation position, for example, it extends at least substantially rearward in the vehicle longitudinal direction, and does not protrude excessively into a foot well of the driver or of the passenger, for example. Thus, the driver can sit in the driver's seat, for example, and at the same time can move the lever easily and conveniently into the actuation position, thereby deactivating the parking lock and in particular holding it deactivated. Therefore, a person seated in the driver's seat, for example, can deactivate the parking lock and hold it deactivated, while at the same time operating the steering wheel and/or the brake of the motor vehicle.

In a further embodiment of the invention, the component is configured as a center console of the motor vehicle. This allows the actuating element to be actuated by means of the lever over a short path, and thus by applying only a low level of force, allowing the parking lock to be deactivated easily.

Finally, it has proven particularly advantageous for the actuating element to comprise a Bowden cable coupled to the lever. Thus, when the lever is moved from the home position to the actuation position, for example, a tractive force is exerted on the cable. The parking lock is thereby deactivated via the Bowden cable.

The first longitudinal region preferably has a greater length extending in the longitudinal direction of extension of the lever than the second longitudinal region, wherein the cable is preferably connected to the lever in the first longitudinal region. In this way, particularly advantageous gear ratios can be realized, so that the parking lock can be deactivated easily.

The invention also comprises combinations of the described embodiments. In the following, exemplary embodiments of the invention are described. In the drawings:

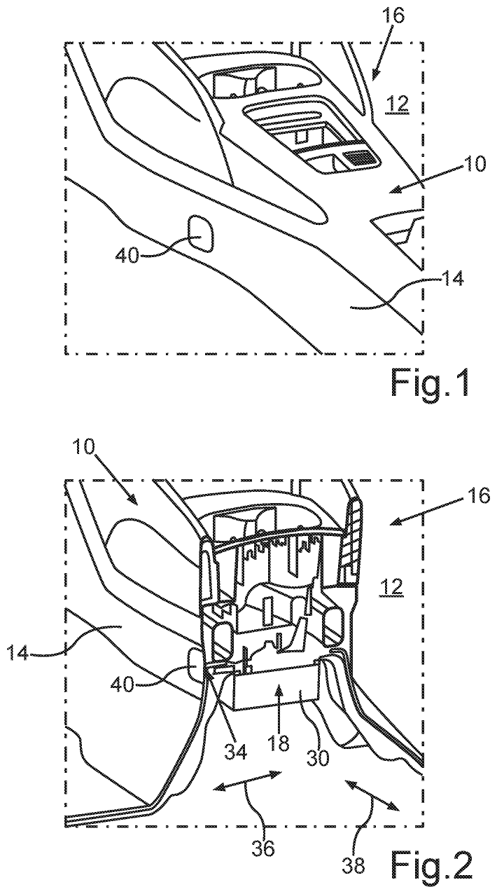

FIG. 1 shows a detail of a schematic perspective view of a center console of an actuating device for a motor vehicle;

FIG. 2 shows a detail of a schematic and perspective sectional view of the center console;

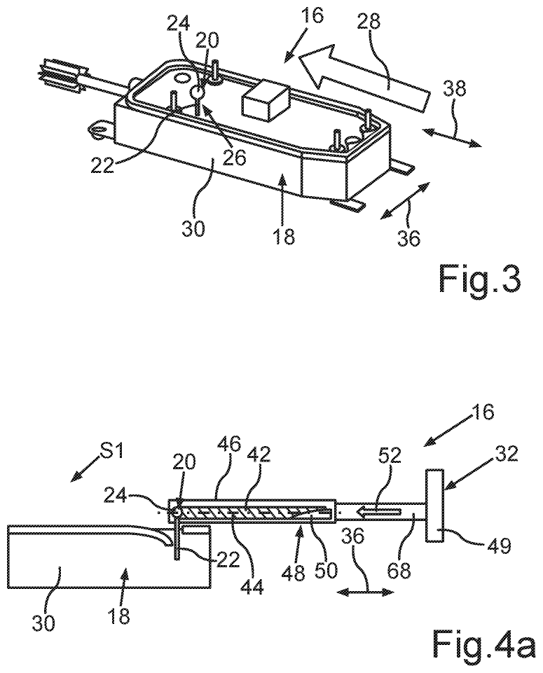

FIG. 3 shows a schematic perspective view of an actuator for actuating a parking lock of the transmission;

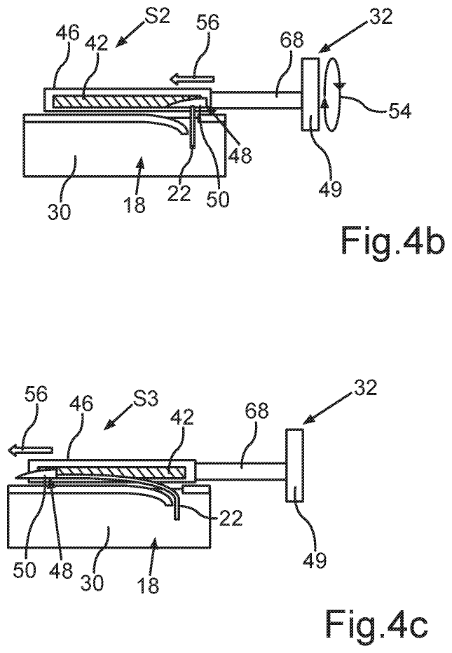

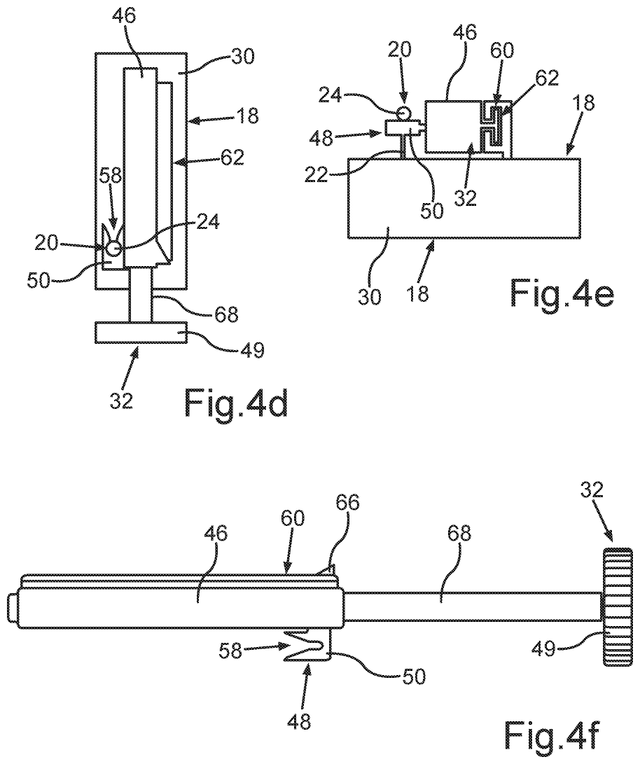

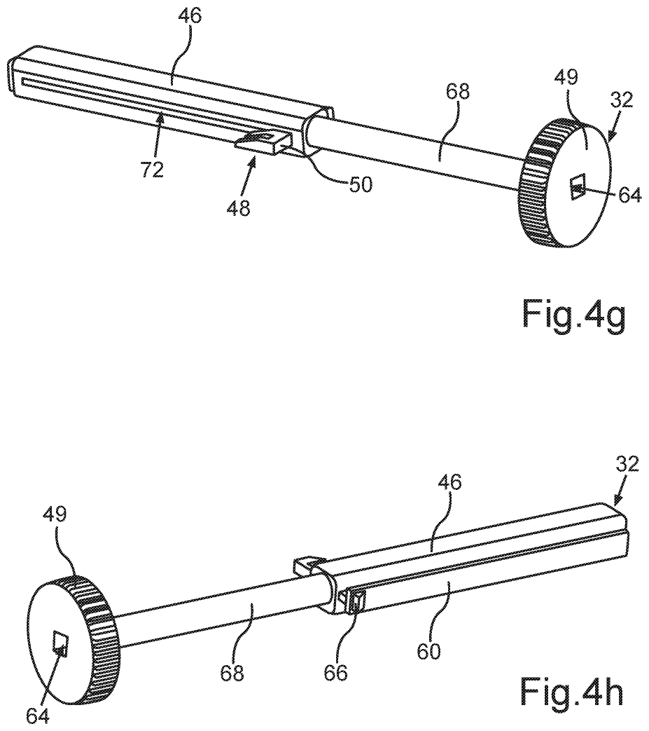

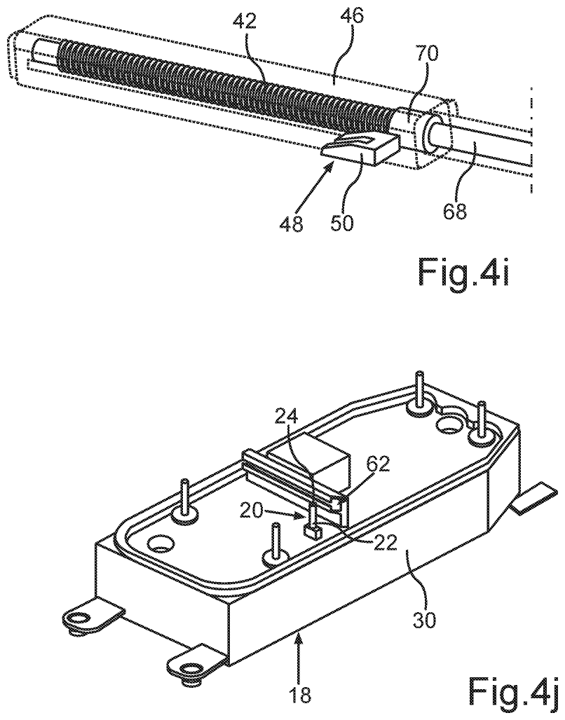

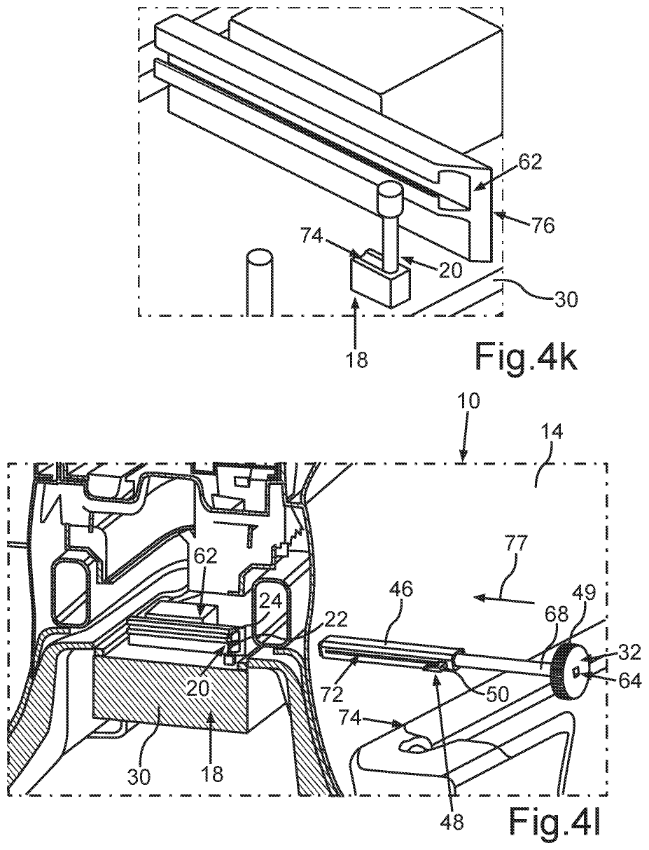

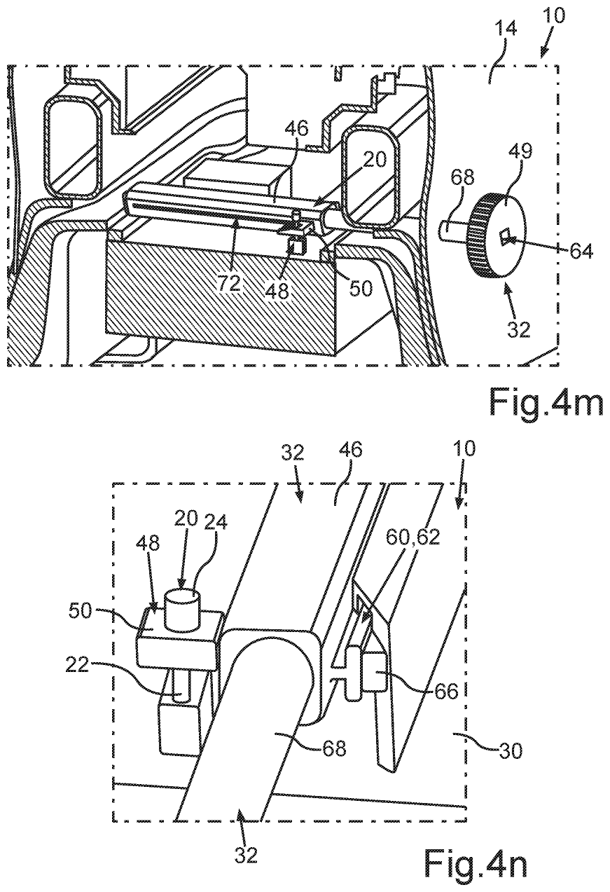

FIGS. 4a-c each show a detail of a schematic and sectional side view of an actuating device of the invention according to a first embodiment, which comprises, for example, the center console according to FIGS. 1 and 2;

FIG. 4d shows a detail of a schematic plan view of the actuating device according to the first embodiment;

FIG. 4e shows a detail of a schematic rear view of the actuating device according to the first embodiment;

FIG. 4f shows a detail of a schematic side view of a tool of the actuating device according to the first embodiment;

FIGS. 4g, h each show a schematic perspective view of the tool according to FIG. 4f;

FIG. 4i shows a detail of a schematic perspective view of the tool according to FIGS. 4f-h;

FIG. 4j shows a schematic perspective view of the actuator for the first embodiment of the actuating device;

FIG. 4k shows a detail of a schematic perspective view of the actuator according to FIG. 4j;

FIGS. 4l, m each show a detail of a schematic and perspective sectional view of the actuating device according to the first embodiment;

FIG. 4n shows a detail of a schematic perspective view of the actuating device according to the first embodiment;

FIG. 4o shows a detail of a schematic and sectional perspective view of the actuating device according to the first embodiment;

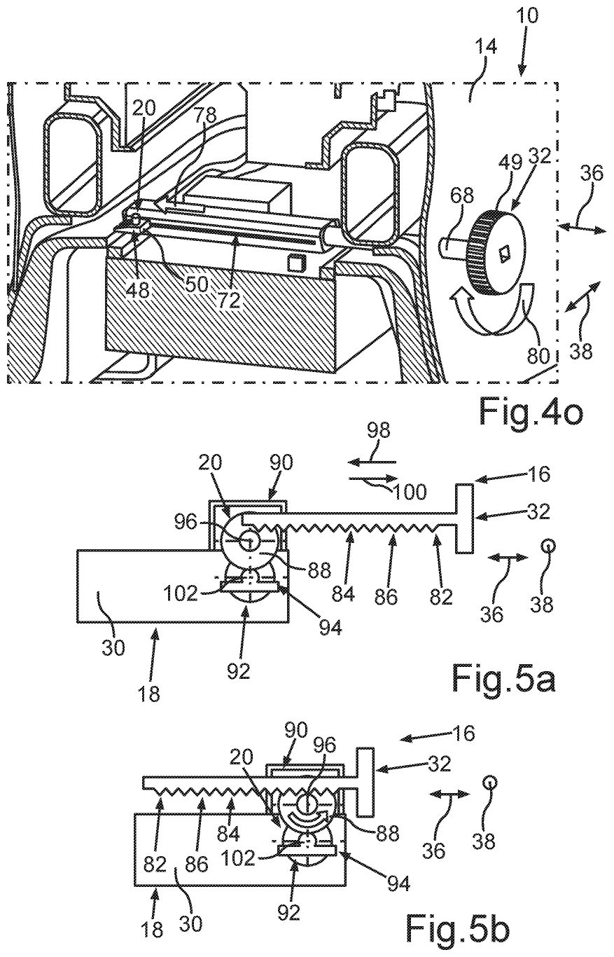

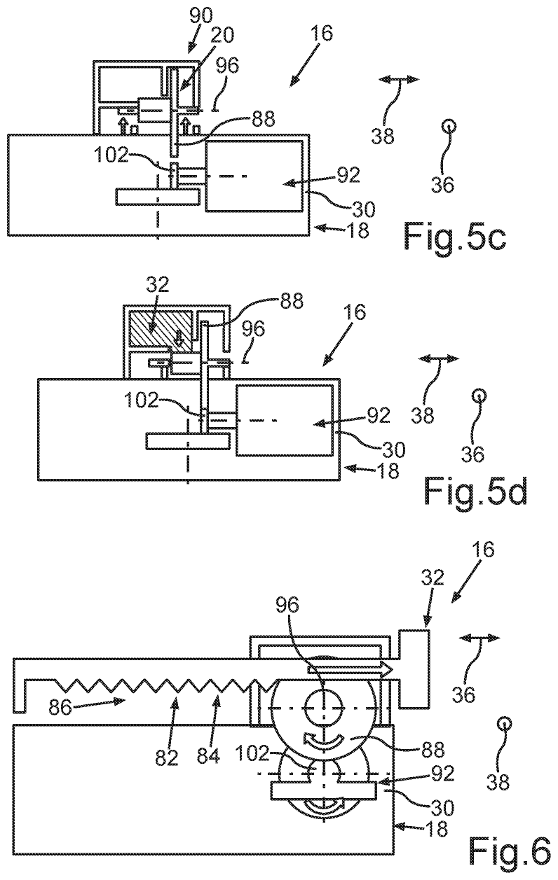

FIGS. 5a, b each show a detail of a schematic sectional view of the actuating device according to a second embodiment;

FIGS. 5c, d each show a detail of a schematic sectional view of the actuating device according to the second embodiment;

FIG. 6 shows a detail of a schematic side view of the actuating device according to a third embodiment;

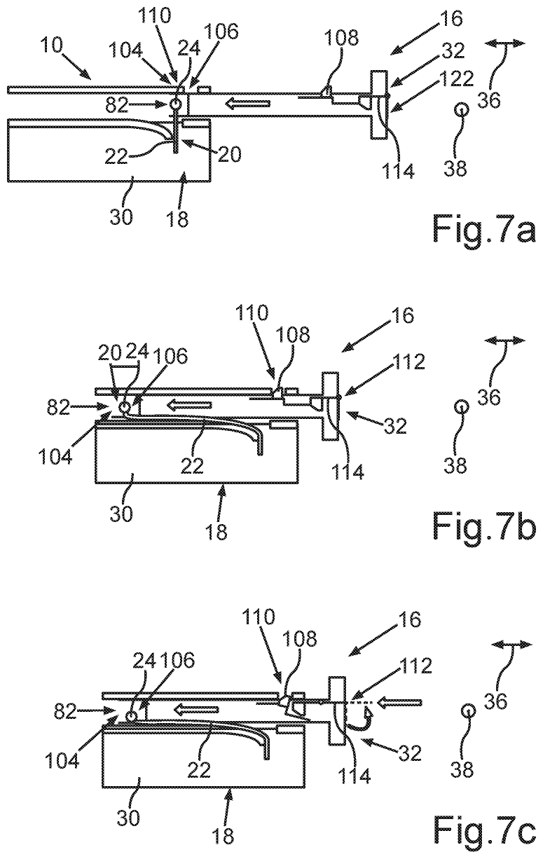

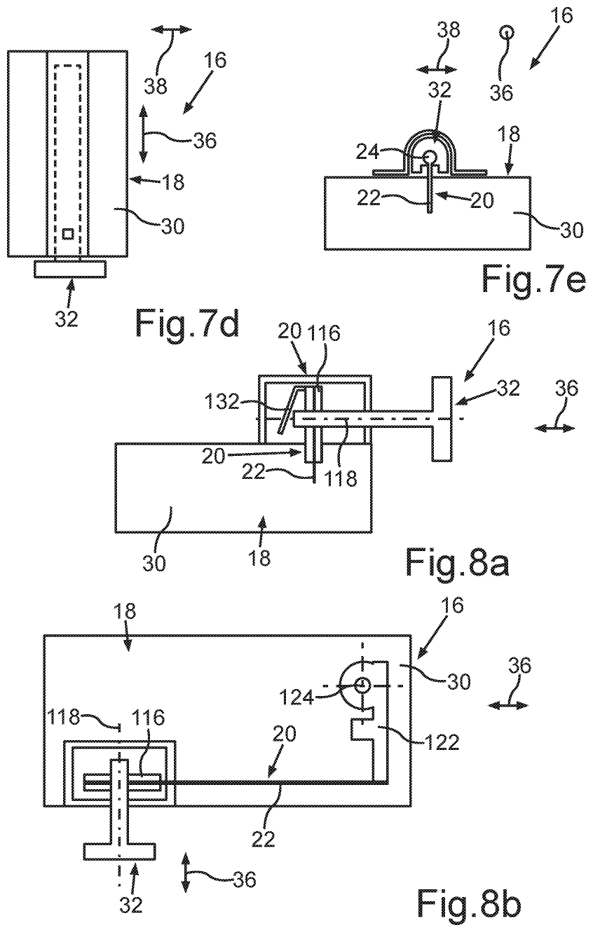

FIGS. 7a-c each show a detail of a schematic and sectional side view of the actuating device according to a fourth embodiment;

FIG. 7d shows a detail of a schematic plan view of the actuating device according to a fourth embodiment;

FIG. 7e shows a detail of a schematic rear view of the actuating device according to the fourth embodiment;

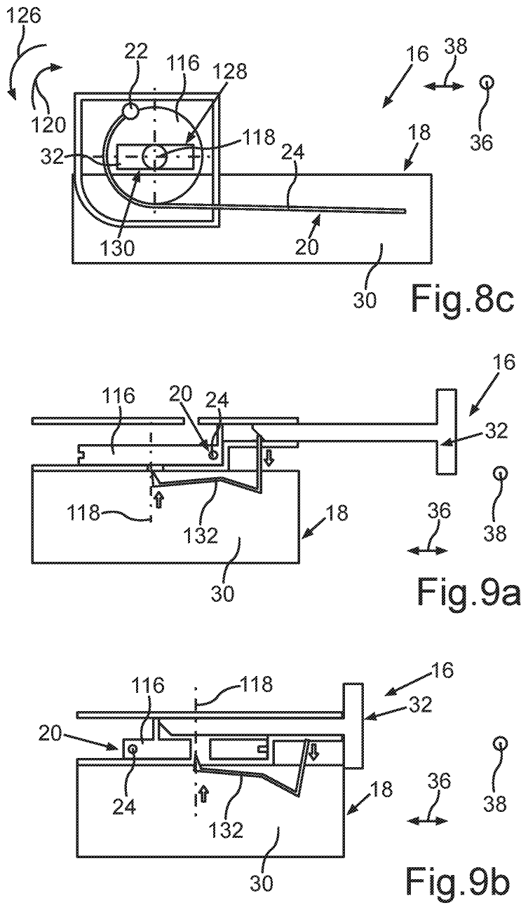

FIG. 8a shows a detail of a schematic and sectional side view of the actuating device according to a fifth embodiment;

FIG. 8b shows a detail of a schematic plan view of the actuating device according to the fifth embodiment;

FIG. 8c shows a detail of a schematic and sectional side view of the actuating device according to the fifth embodiment;

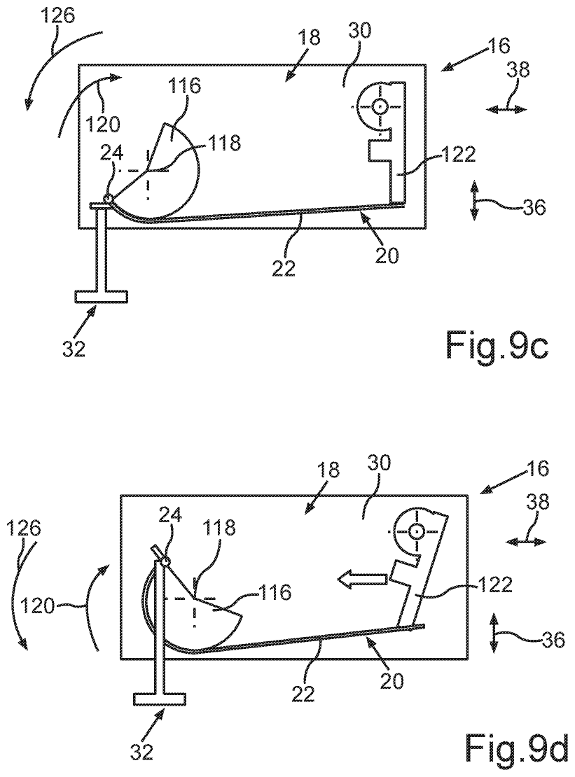

FIGS. 9a, b each show a detail of a schematic and sectional side view of the actuating device according to a sixth embodiment;

FIGS. 9c, d each show a detail of a schematic plan view of the actuating device according to the sixth embodiment;

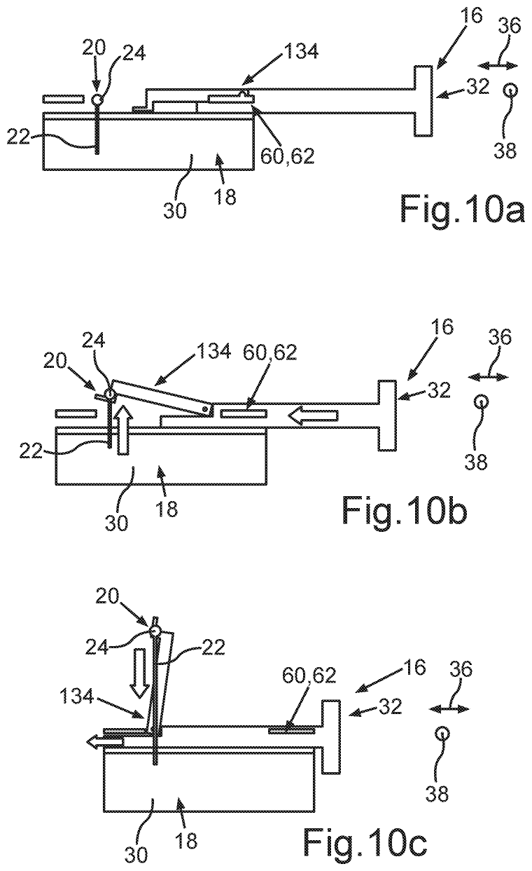

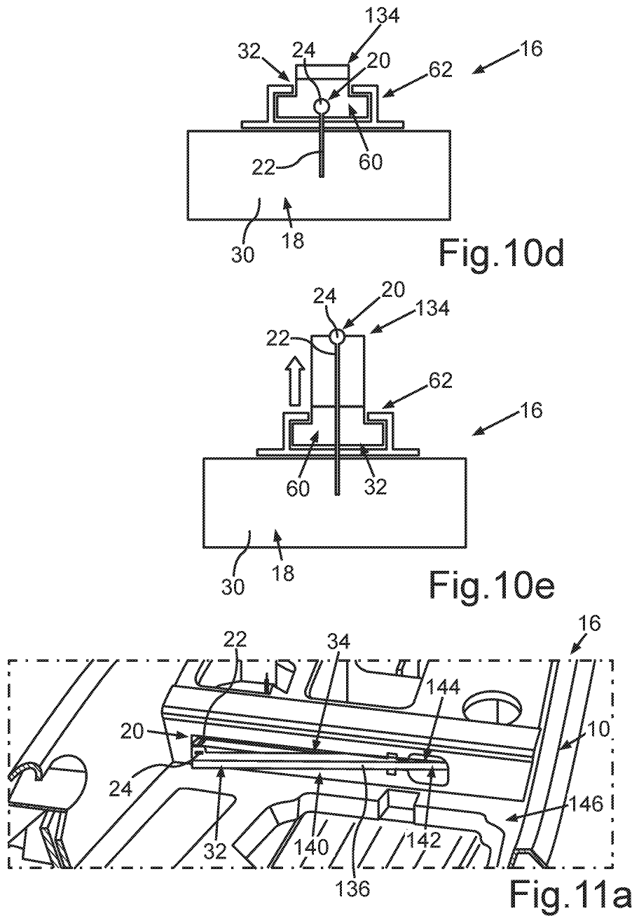

FIGS. 10a-c each show a detail of a schematic and sectional side view of the actuating device according to a seventh embodiment;

FIGS. 10d, e each show a detail of a schematic and sectional rear view of the actuating device according to the seventh embodiment;

FIGS. 11a, b each show a detail of a schematic perspective view of the actuating device according to an eighth embodiment; and

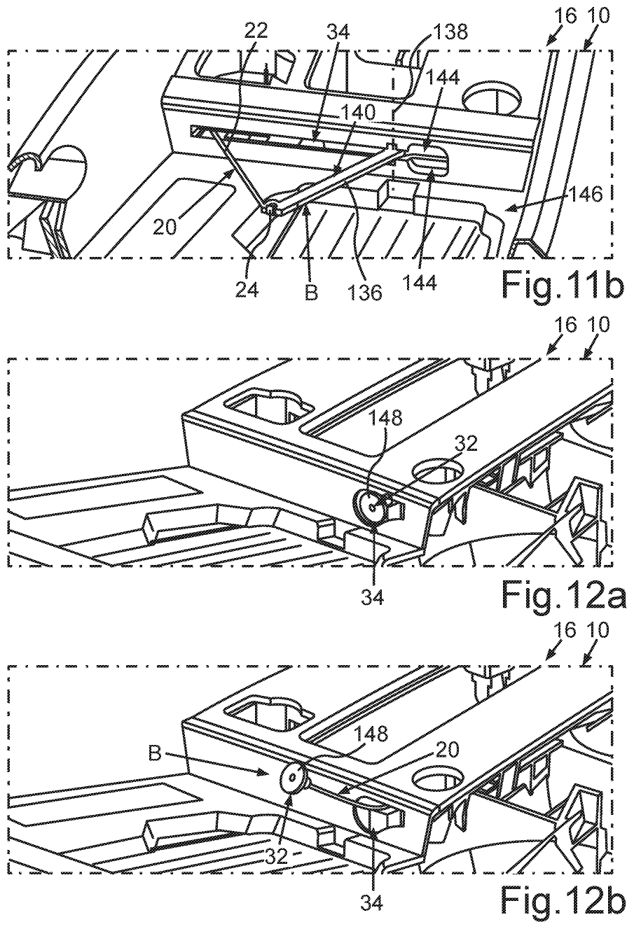

FIGS. 12a, b each show a detail of a schematic perspective view of the actuating device according to a ninth embodiment.

The exemplary embodiments explained in the following are preferred embodiments of the invention. In the exemplary embodiments, the described components of the embodiments each represent individual features of the invention to be considered independently of one another, which each also refine the invention independently of one another and are thus considered to be part of the invention, either individually or in a combination other than that described. Furthermore, the described embodiments can also be supplemented by additional of the above-described features of the invention. In the figures, functionally identical elements are provided with the same reference signs.

FIG. 1 shows a detail, in a schematic perspective view, of a center console 10 of a motor vehicle preferably configured as an automobile, the center console 10 in FIG. 1 being shown in its installed position. The center console 10 occupies its installed position shown in FIG. 1 when the motor vehicle is in its fully produced state. In this fully produced state of the motor vehicle, the center console 10 is located in the passenger compartment 12 of the motor vehicle. The center console 10 comprises a side wall 14, for example, which delimits, at least partially, in particular at least predominantly or completely, a foot well of the driver or front seat passenger of the motor vehicle, for example, in the vehicle transverse direction, in particular toward a foot well of the front seat passenger or driver of the motor vehicle. The center console 10 is part of an actuating device, denoted as a whole by 16, and described in greater detail in the following. FIGS. 4a-o, for example, depict a first embodiment of the actuating device 16, wherein the center console 10 is or can be used in the first embodiment.

The actuating device 16 serves to mechanically and manually deactivate and thus unlock an emergency release of a transmission of the motor vehicle, and thereby to deactivate and thus unlock a parking lock of said transmission. The motor vehicle, in its fully produced state, comprises the transmission and at least one drive motor, wherein the motor vehicle or at least one wheel of the motor vehicle can be driven, for example, via the transmission by the drive motor. For this purpose, the transmission comprises at least a transmission housing and a transmission output shaft, which is coupled, for example, to the at least one wheel. The transmission output shaft is at least partially accommodated in the housing and can in principle rotate around an axis of rotation relative to the housing. The aforementioned parking lock can be activated or engaged and deactivated or disengaged. When the parking lock is engaged, the transmission output shaft is secured against rotation around the axis of rotation relative to the housing, so that the transmission output shaft and thus the wheel cannot rotate around the axis of rotation relative to the housing. The motor vehicle is thus prevented from rolling away unintentionally, in particular if the motor vehicle is stopped and/or parked on a slope. When the parking lock is deactivated or disengaged, the parking lock releases the transmission output shaft for rotation around its axis of rotation relative to the housing. Thus, when the parking lock is activated, the transmission is mechanically blocked.

FIG. 3 shows an actuator 18, which is an electrically operable actuator, for example, and comprises for this purpose at least one electric motor, for example. By means of the actuator 18, the parking lock can be electrically at least deactivated or disengaged. For this purpose, the actuator 18 is supplied with electric current. In this way, it is possible to deactivate the parking lock, for example, in that a person located in the passenger compartment 12 actuates an operating element located in the passenger compartment 12 to deactivate the parking lock, without a direct mechanical connection being provided between the operating element and the parking lock for this purpose. When the person actuates the operating element, an electrical signal that characterizes the actuation of the operating element is detected in the functional state of the motor vehicle. As a result of the detection of the signal, the actuator 18 is actuated in order to deactivate the parking lock by means of the actuator 18 via activation of the actuator 18. Since the parking lock can thus be deactivated without a mechanical connection existing between the operating element and the parking lock, a shift-by-wire actuation of the parking lock is provided.

However, if the parking lock is initially activated and a power failure then occurs, resulting in a malfunction of the motor vehicle, so that the actuation of the operating element will not result in the aforementioned electrical signal, and the actuator 18 cannot be electrically operated, the emergency release of the transmission and, via this, the parking lock can be mechanically actuated manually by means of the actuating device 16 by a person located in the passenger compartment 12, whereby the parking lock is manually and mechanically deactivated. The emergency transmission release in this case is a component part of the actuator 18, for example.

For this purpose, the actuating device 16 comprises, for example, at least one vehicle-fixed actuating element 20, particularly clear from FIG. 3, by means of which or via which the parking lock can be manually and mechanically deactivated. In the exemplary embodiment illustrated in FIG. 3, the actuating element 20 comprises, for example, a pulling means in the form of a control cable 22, also referred to as a Bowden cable. In addition, the actuating element 20 comprises, for example, a shaped piece 24, also referred to as a head, which is arranged at one end 26 of the control cable 22 and is connected to the control cable 22. To deactivate the parking lock, a force, particularly in the form of a tractive force, is exerted on the actuating element 20. The tractive force is at least indirectly transmitted to the parking lock via the actuating element 20, thereby mechanically and manually deactivating the parking lock. To transmit the force to the actuating element 20 and as a result to the parking lock, the actuating element 20 is pulled. Furthermore, an arrow 28 indicates the forward travel direction of the motor vehicle in FIG. 3.

In particular, the actuating element 20 is coupled to the parking lock via an actuating mechanism of the actuator 18, which is not visible in FIG. 3 and is accommodated, for example, in a housing 30 of the actuator 18, so that the parking lock can be mechanically and manually deactivated, i.e. disengaged, by means of the actuating element 20 via the actuating mechanism. The actuating mechanism is a gear mechanism, for example, and/or has a gear ratio other than 1. In this way, for example, forces or torques exerted manually by the person on the actuating element 20 can be converted into higher forces or torques in relation thereto, which act on the parking lock. The parking lock can thus be deactivated even using only low levels of force or torque exerted manually by the person on the actuating element 20, so that the parking lock can be disengaged easily and conveniently.

The actuating device 16 additionally comprises a tool 32, particularly clear from FIGS. 4a-c and configured as separate from the actuating element 20, via which tool the actuating element 20 is manually and mechanically actuatable to manually deactivate the parking lock. In other words, the person can manipulate the tool 32 and, via the tool 32, can manually and mechanically actuate the actuating element 20, to thereby manually and mechanically deactivate the parking lock. In this way, the parking lock can be deactivated even in the event of a power failure. The feature that the tool 32 is configured as separate from the actuating element 20 is understood, in particular, to mean that the actuating element 20 and the tool 32 are configured as at least two components configured as separate from one another, which can cooperate to thereby actuate the actuating element 20 by means of the tool 32.

In order now to enable emergency release of the transmission, and via this, deactivation of the parking lock in a particularly easy and convenient manner, in particular manually and mechanically, the actuating device 16 comprises, as is particularly clear from FIGS. 1 and 2, at least one through opening 34, which is formed in the center console 10 that is or can be located in the passenger compartment 12 of the motor vehicle, and which is thus formed in the side wall 14 and has a passage direction indicated in FIG. 2 by a double arrow 36. The passage direction extends in this case in an imaginary plane spanned by the vehicle transverse direction and the vehicle longitudinal direction, wherein the vehicle longitudinal direction is indicated by a double arrow 38 in FIG. 2 and coincides with the forward travel direction indicated by the arrow 28 in FIG. 3. In the first embodiment and/or in the exemplary embodiment illustrated in FIGS. 1 and 2, the passage direction of the through opening 34 extends along the vehicle transverse direction or the passage direction coincides with the vehicle transverse direction, so that in FIG. 2, the vehicle transverse direction is indicated by the double arrow 36. The through opening 34 can be penetrated by the tool 32 along the passage direction, to thereby bring the tool 32 into cooperation with the actuating element 20, to thereby mechanically and manually actuate the actuating element 20, and to thereby mechanically and manually deactivate the parking lock.

In the first embodiment, the tool 32 is configured as a tool that is separate from the center console 10, and that is pushed through the through opening 34 in or along the passage direction, to thereby bring the tool 32 into cooperation with the actuating element 20. As is particularly clear from FIGS. 1 and 2, the through opening 34 is associated with a cover element 40 configured as a lid, for example, by means of which the through opening 34 is or can be closed. In particular, the cover element is reversibly held detachably on the center console 10. To move the tool 32 in the passage direction relative to the center console 10 and thereby insert it through the through opening 34, the cover element 40 is removed out of or from the through opening 34, thereby exposing the through opening 34.

As is clear from FIG. 1, in the exemplary embodiment illustrated in FIG. 1, for example, access to the actuating element 20 via the through opening is provided from left to right in the vehicle transverse direction. Alternatively, access may be from the right or via a removable component or panel. The through opening 24 could be left entirely open. A holder, also referred to as a multifunction holder, can be used as the cover element 44, for example, on which, for example, objects can be held or suspended.

In the first embodiment, the tool 32 comprises a threaded spindle 42, which is rotatable, for example, around an axis of rotation 44 relative to a housing 46 of the tool 32. In this case, the tool 32 comprises the housing 46, in which the threaded spindle 42 is at least partially, in particular at least predominantly or completely, accommodated. The tool 32 further comprises an operating part 49 configured as a rotary knob, for example, via which, for example, the threaded spindle 42 can be rotated around the axis of rotation 44 relative to the housing 46. The tool 32 further comprises a movement element 48, which is translationally movable, i.e., displaceable, by a relative rotation between the threaded spindle 42 and the movement element 48 along the threaded spindle 42 and at the same time along the axis of rotation 44 relative to the center console 10 and relative to the housing 46, to thereby actuate the actuating element 20. The movement element 48 comprises, for example, a nut (not visible in the figure), which is screwed onto the threaded spindle 42. The movement element 48 additionally comprises a slide 50, for example. The movement element 48 is secured against rotation around the axis of rotation 44, for example, relative to the housing 46. Thus, when the threaded spindle 42, for example, is rotated around the axis of rotation 44 relative to the housing 46, in particular via the rotary knob, the movement element 48 does not also rotate around the axis of rotation 44 relative to the housing 46. The threaded spindle 42 comprises an external thread, and the movement element 48, in particular the nut, comprises an internal thread corresponding to the external thread. The threaded spindle 42 and the nut are screwed together via the external thread and the internal thread. In other words, the nut is screwed via its internal thread, for example, onto the threaded spindle 42 via the external thread. The external thread and the internal thread are also referred to as threads. By means of the thread, the described relative rotation between the threaded spindle 42 and the movement element 48, in particular the nut, is converted into a translational movement of the movement element 48 along the axis of rotation 44 relative to the housing 46.

In a first step S1 that is clear from FIG. 4a, the tool 32 is inserted along the passage direction through the through opening 34, for example. The actuating element 20, in particular the shaped piece 24, is thereby inserted into the housing 46, for example, and brought into cooperation, in particular positive cooperation, with the movement element 48, in particular with the slide 50. For this purpose, the slide 50 has a recess, for example, in which the shaped piece 24 comes to rest. This insertion of the tool 32 into or through the through opening 34 is indicated in FIG. 4a by an arrow 52. In a second step S2 illustrated in FIG. 4b, the threaded spindle 42 is then rotated around the axis of rotation 44 relative to the housing 46 and relative to the movement element 48, as indicated in FIG. 4b by an arrow 54. The movement element 48 is thereby moved along the axis of rotation 44 relative to the housing 46, as indicated by an arrow 56 in FIG. 4b.

Since the slide 50 cooperates in a positive manner with the shaped piece 24 and thus with the actuating element 20, in a third step S3 illustrated in FIG. 4c, a force particularly in the form of a tractive force is exerted on the actuating element 20 by the described movement of the movement element 48. In the first embodiment, the Bowden cable 22 is pulled via the shaped piece 24, thereby deactivating or releasing the parking lock. This is illustrated in FIG. 4c. Overall, it is clear from FIGS. 4a-c that the tool 32 penetrates the through opening 34 in the vehicle transverse direction or along the passage direction in a state in which the parking lock is released by means of the tool 32.

The shaped piece 24 is a flex shaft, for example, which is captured and ultimately pulled in the described manner by the slide 50, which is configured as a catch hook, for example. In the described manner, the actuating element 20 is moved into a release position, for example, in which the parking lock is deactivated. The threaded spindle 42 preferably has self-retention, so that the movement element 48 and the actuating element 20 are held by the self-retention in the release position. In this way, the parking lock is held deactivated by the self-retention of the threaded spindle 42.

The parking lock is thereby released or deactivated, in particular, by rotating the threaded spindle 42 in a first rotational direction around the axis of rotation 44 relative to the housing 46. To re-lock or reactivate the parking lock, the threaded spindle 42 is rotated, for example, via the operating part 49 in a second rotational direction opposite the first rotational direction around the axis of rotation 44 relative to the housing 46. The movement element 48 is thereby pushed back out of the release position, thereby allowing the actuating element 20 to also retract. As a result, the parking lock is reactivated. Alternatively or additionally, it is conceivable to activate the parking lock in such a way that the tool 32 is simply pulled back out of the through opening 34.

As is particularly clear from FIG. 4d, the slide 50 may be configured as a catch hook. The slide 50 comprises, for example, the aforementioned recess identified by 58 in FIG. 4d, which is open in particular along the passage direction. In this way, the actuating element 20 can be moved into the recess 58 by moving the tool 32 along the passage direction relative to the actuating element 20.

As is particularly clear from FIG. 4e, the tool 32 comprises a first guide element 60. The guide element 60 is provided on the housing 46, for example, and has, for example, an at least substantially T-shaped cross-section. Provided on the actuator 18 is a second guide element 62, into which the guide element 60 can be inserted along the passage direction. The guide elements 60 and 62 can cooperate in a positive manner, whereby the tool 32 is guided in a defined manner upon insertion into or through the through opening 34.

The operating part 49 configured as a rotary knob, which can be actuated particularly easily by hand and can thereby be rotated relative to the housing 46 around the axis of rotation 44, is particularly clear from FIG. 4f. As is particularly clear from FIG. 4g, the operating part 49 comprises a tool engagement point 64 configured, for example, as a quadrilateral socket, in particular as a polygonal socket, via which the operating part 49 and thus the threaded spindle 42 can cooperate in a positive manner with a rotating or screwing tool, for example, a drill. By means of the rotary tool, torques can be exerted in a positive manner on the operating part 49 and thus on the threaded spindle 42, in order, for example, to rotate the threaded spindle 42 by means of the rotary tool around the axis of rotation 44 relative to the housing 46. The parking lock can thereby be released particularly quickly and easily.

As is further particularly clear from FIG. 4h, the guide element 60 is configured as a T-rail for guidance on the actuator 18. An angled piece is provided as an end stop 66 in this case. The tool 32 can thus be moved translationally along the passage direction and along the guide element 62 relative to the center console 10 until the end stop 66 comes into supporting contact with the guide element 62 along the passage direction. The tool 32 is then located in an advantageous position, in which the movement element 48 can be moved translationally in the described manner relative to the housing 46 to actuate the actuating element 20 and as a result to deactivate the parking lock.

As is particularly clear from FIG. 4i, the operating part 49 is connected for conjoint rotation to an actuating rod 68, which is in turn connected for conjoint rotation to the threaded spindle 42. In particular, the actuating rod 68 is configured as integral with the threaded spindle 42, for example. In FIG. 4i, the housing 46 is depicted as transparent, so that the nut identified by 70 in FIG. 4i, which is screwed onto the threaded spindle 42, is particularly clear in FIG. 4i. It is also particularly clear from FIG. 4i that the nut 70 is connected to the slide 50 configured as a catch hook.

As is particularly clear from FIG. 4g, the movement element 48 penetrates a slot 72 in the housing 46, for example, and can be moved translationally along the slot 72 relative to the housing 46.

FIG. 4j shows the actuator 18, which is used for the first embodiment. The actuating element 20 and the guide element 62 are particularly clear from FIGS. 4j and 4k. The guide element 62 is configured as a T-piece corresponding to the T-rail for guiding the tool 32. Also provided is a guide piece 74, by means of which the actuating element 20 is guided as it moves into the release position. On its front end face 76, the guide element 62 has a bevel or the guide element 62 is configured as inclined, to enable the T-rail to be threaded particularly easily into the guide element 62.

As indicated in FIG. 4l by an arrow 77, the tool 32 is first inserted through the through opening 34 and thus through the side wall 14. As is particularly clear from FIGS. 4m and 4n, the guide element 60 is thereby brought into positive cooperation with the guide element 62, whereby the tool 32 is guided in a defined manner relative to the center console 10. The tool 32 is inserted through the through opening 34 until the end stop 66 comes into supporting contact with the guide element 62 along the passage direction. The actuating element 20 is then located in the catch hook, in particular in the recess 58 of the movement element 48. When the threaded spindle 42 is then rotated in the first direction of rotation relative to the housing 46, the actuating element 20 is thus moved into the release position, as is clear from FIG. 4o, thereby deactivating the parking lock. This is indicated in FIG. 4o by an arrow 78, with an arrow 80 indicating the rotation of the threaded spindle 42 and thus of the rotary knob in the first rotational direction.

FIGS. 5a-d illustrate a second embodiment of the actuating device 16. In the second embodiment, the tool 32 is configured as a push rod, which is formed as a single piece in particular, and which can be pushed through the through opening 34 along the passage direction. The push rod in this case comprises a positive-fit device 82, which can be brought into positive cooperation with the actuating element 20 to actuate the actuating element 20. In the second embodiment, the positive-fit device 82 has external gear teeth 84, which comprise a plurality of teeth 86 arranged in succession along the passage direction.

In the second embodiment, the actuating element 20 is a gear wheel 88, for example, having further external gear teeth, which can interact with the external gear teeth 84. The gear wheel 88 is a component of a release attachment 90, for example, and can be a component part of gearing, also referred to as release gearing. As is clear from FIG. 5a, the actuator 18 can actuate the aforementioned electric motor identified by 92 in FIG. 5a, for example, and comprises a transmission mechanism 94, which can be actuated via the gear wheel 88. The gear wheel 88 is rotatable around an axis of rotation 96 relative to the housing 30 of the actuator 18. When the push rod is then displaced along the passage direction relative to the housing 30 and relative to the center console 10, so that the external gear teeth 84 cooperate with the external gear teeth of the gear wheel 88, the gear wheel 88 is thereby rotated around the axis of rotation 96 relative to the housing 30. As a result, the transmission mechanism 94 and the electric motor 92 of the actuator 18 are rotated, thereby deactivating the parking lock via the actuator 18, in particular the transmission mechanism 94, by means of the push rod. In other words, by pushing the push rod, configured as a toothed rack, along the passage direction relative to the center console 10, the electric motor 92 is moved, in particular rotated, so that the provided transmission mechanism 94 of the actuator 18 is actuated. The parking lock is thereby deactivated. In this case, the push rod is pushed in a first direction, indicated in FIG. 5a by an arrow 98, which coincides with the passage direction, thereby deactivating the parking lock. When the push rod is moved translationally in a second direction, indicated by an arrow 100 in FIG. 5a, which is opposite the first direction, in particular relative to the housing 30 and/or relative to the center console 10, the parking lock is thus reactivated.

The gear wheel 88 is used, for example, as the release gearing or as a component of the release gearing, wherein, by means of the release gearing, the parking lock can be manually and mechanically released by means of the tool 32. It is conceivable in this case, for example, for the gear wheel 88 to be pressed onto the electric motor 92 or onto a corresponding gear wheel 102 of the release gearing by means of the tool 32, so that the release gearing does not always actively run along when the parking lock is deactivated by means of the electric motor 92. In this way, the tool 32 could be permanently installed or held at least indirectly, in particular directly, on the center console 10.

As is illustrated in FIG. 5b, the gear wheels 88 and 102 are rotated accordingly when the push rod is pushed in the first direction. FIG. 5c shows the actuating device 16 of the second embodiment in an idle position, in which, for example, the push rod does not cooperate with the gear wheel 88. In the idle position, the gear wheel 88 is decoupled from the gearwheel 102 and thus from the electric motor 92, so that when the parking lock is deactivated by means of the electric motor 92, the gear wheel 88 is not rotated by means of the electric motor 92. However, when the push rod (tool 32) is then brought into cooperation with the gear wheel 88 (actuating element 20), as illustrated in FIG. 5d, the gear wheel 88 is coupled to the gear wheel 102. As a result, the electric motor 92 is actuated, in particular rotated, by the push rod via the gear wheel 102 and the gear wheel 88, thereby deactivating the parking lock, for example.

FIG. 6 shows a third embodiment, in which the push rod is pulled out of the center console 10 to deactivate the parking lock. In contrast thereto, it is provided in the second embodiment that the push rod is pushed into the center console 10 to deactivate the parking lock. In the third embodiment, for example, a functional principle is thus provided, which is opposite the functional principle of the second embodiment, in particular with respect to the direction in which the tool 32 is to be moved translationally to deactivate the parking lock. In particular, the tool 32 enables a currentless actuation and, in particular, deactivation of the parking lock.

The release gearing is used to implement revolutions required for the deactivation of the parking lock, in particular of the electric motor 92 or its rotor. Via the release gearing, the existing electric motor 92 is moved by mechanical work, which is provided, for example, via the tool 32 and is transmitted to the release gearing.

The second and third embodiments are to be regarded as separate aspects or subjects independent of the other embodiments and exemplary embodiments, and can thus represent intrinsic, separate, and independent inventions.

FIGS. 7a-e illustrate a fourth embodiment of the actuating device 16. In the fourth embodiment, the tool 32 is likewise configured as a push rod, wherein the positive-fit device 82 comprises a recess 106, arranged on a front end face 104 of the push rod, for catching and accommodating the actuating element 20. When the push rod is pushed along the passage direction through the through opening 34 and thereby inserted into the center console 10, the actuating element 20 is thus captured by the push rod via the recess 106 and is pulled to the rear or moved into the release position by the pushing movement of the push rod.

In this case, at least one first detent element 108 is held on the push rod. A second detent element 110, corresponding to the detent element 108, with which the detent element 108 can be interlocked, is provided on the actuator 18, in particular the housing 30 thereof, and/or on the center console 10.

As is clear from FIG. 7b, the detent element 108 engages in the detent element 110, whereby the detent elements 108 and 110 cooperate positively. The actuating element 20 can thereby be held in the release position.

To disengage the detent elements 108 and 110 from one another, a lever actuation unit 112 is provided. The lever actuation unit 112 comprises at least one lever 114 held pivotably on the push rod, by means of which the detent elements 108 and 110 can be disengaged from one another, for example. For this purpose, for example, the detent element 108 is moved by means of the lever 114, for example, out of the detent element 110, which is configured as a recess, for example. As a result, the push rod can be pulled out of the center console 10. The actuating element 20 can move out of the release position as a result, thereby reactivating the parking lock. The detent elements 108 and 110 are thus disengaged from one another, in particular, by means of the lever actuation unit 112 in that the lever actuation unit 112 is folded open and pushed toward the detent element 108. In this way, the lever 114 presses the detent element 108 downward and out of the detent element 110, for example.

FIG. 7d shows the push rod according to the fourth embodiment in a state in which the parking lock is deactivated. FIG. 7e shows the actuating device 16 according to the fourth embodiment in a view from the rear.

FIGS. 8a-c show a fifth embodiment of the actuating device 16. In the fifth embodiment, a roller 116 is provided, which is held rotatably, for example, on the actuator 18, in particular on the housing 30. The roller 116 can be rotated around an axis of rotation 118 relative to the housing 30. The tool 32 is configured, for example, as a push rod or as a key, with the tool 32 and the roller 116 being configured as components that are separate from one another, for example. In particular, the roller 116 can be a component of the actuating element 20. As is clear from FIG. 8c, the Bowden cable 22 is connected in a positive manner to the roller 116 via the shaped piece 24, for example. When the roller 116 is then rotated around the axis of rotation 118 in a first rotational direction, indicated by an arrow 120 in FIG. 8c, the cable pull 22 is pulled as a result. In this way, a lever 122 that is clearly shown in FIG. 8b is pivoted, for example. The lever 122 is held pivotably on the housing 30, for example, and can be pivoted around a pivot axis 124 relative to the housing 30. By rotating the roller 116, the parking lock can be deactivated. When the roller 116 is then rotated in a second rotational direction, which is opposite the first rotational direction and is indicated by an arrow 126 in FIG. 8c, the parking lock is thereby reactivated.

To enable the roller 116 to be rotated by means of the tool 32 around the axis of rotation 118, the tool 32 is inserted into a corresponding recess 128 of the roller 116, for example. The recess 128 is configured as non-round on the inner circumference side, and a region 130 of the tool 32 is also configured as non-round on the outer circumference side. The region 130 is inserted into the recess 128, enabling the tool 32 to cooperate with the roller 116 in a positive manner via the region 130 in the recess 128. Torques, by means of which the roller 116 can be rotated in the first rotational direction relative to the housing 30, can thereby be transmitted from the tool 32 to the roller 116. The insertion of the tool 32 into the roller 116 or into the recess 128 is particularly clear from FIG. 8b.

A pawl 132, which is clear from FIG. 8a, is furthermore provided, by means of which the roller 116 can be secured against rotation around the axis of rotation 118 relative to the housing 30. When the push rod (tool 32) configured as a key, for example, is inserted into the roller 116, in particular the recess 128, the pawl 132 is thus activated, whereby the pawl 132 secures the roller 116, in particular in a positive manner, against rotation in the second rotational direction. Thus, the roller 116 cannot rotate in the second rotational direction while the tool 32 is inserted into the roller 116. When the tool 32 is pulled out of the roller 116, the pawl 132 is thus disengaged or deactivated, so that the roller 116 can then rotate in the second rotational direction. The parking lock can thereby be reactivated. As is clear from FIGS. 8a-c, the axis of rotation 118 extends in the plane spanned by the vehicle longitudinal direction and the vehicle transverse direction and thus extends in the vehicle transverse direction, so that, for example, the axis of rotation 118 coincides with the passage direction. The roller 116 is thus configured as a vertical roller.

FIGS. 9a-d show a sixth embodiment, which differs from the fifth embodiment in particular in that the roller 116 is configured as a horizontal roller. In that case, the rotational axis 118 extends perpendicular to said plane, and in particular in the vehicle vertical direction. It is further particularly clear from FIGS. 9a, b that the roller 116, which is configured as a disk, for example, can be locked, in particular in its end position, by means of the pawl 132. When the tool 32 is pulled out of the through opening 34 or out of the center console 10, the roller 116 is thus released, whereupon the parking lock can be reactivated.

As is clear from FIGS. 9c, d, in the sixth embodiment the roller 116 is rotated around the axis of rotation 118, for example, in that the tool 32 is displaced along the passage direction relative to the center console 10. This displacement of the tool 32 is converted into a rotation of the roller 116. In contrast thereto, in the fifth embodiment it is provided that the tool 32 is rotated around the axis of rotation 118 relative to the center console 10 in order to rotate the roller 116 relative to the center console 10 and as a result to deactivate the parking lock.

In other words, in the sixth embodiment it is provided that the tool 32, which is configured as part of a vehicle tool kit, for example, presses on the horizontal roller 116, to thereby move the actuating element 20 into the release position. Upon insertion of the tool 32, the pawl 132 is actuated, thereby preventing the rotation of the roller 116 in the second rotational direction. Upon withdrawal of the tool 32, the pawl 132 is disengaged, thereby allowing the roller 116 to rotate back in the second rotational direction.

FIGS. 10a-c show a seventh embodiment of the actuating device 16. In the seventh embodiment, the tool is once again configured as a push rod, for example, on which a toggle lever 134 is provided. In other words, in the seventh embodiment the tool 32 comprises at least one toggle lever 134, for example, for actuating the actuating element 20. The actuation of the actuating element 20 by means of the toggle lever 134 is particularly clear from FIGS. 10b-e. The actuating element 20 is captured by the toggle lever 134 and pulled upward by the pushing movement of the tool 32. In an end position, the toggle lever 134 is in a top dead-center position, for example, whereby the actuating element 20 is held automatically in the release position. This top dead-center position is particularly clear from FIG. 10c. The parking lock can thus be reactivated, in particular, only by actively withdrawing the tool 32 from the center console 10. An activation of the parking lock induced by the actuating element 20 or by the parking lock itself can thus be prevented.

FIGS. 11a, b show an eighth embodiment of the actuating device 16. In the eighth embodiment, the tool 32 is configured as a vehicle-fixed tool, which is held at least indirectly, in particular, directly on the center console 10. In this case, the tool 32 comprises a lever 136, which is held on the center console 10 such that it is pivotable around a pivot axis relative to the center console 10. The pivot axis in this case extends perpendicular to the planes spanned by the vehicle transverse direction and the vehicle longitudinal direction, and thus in the vehicle vertical direction. The through hole 34 extends in this case in a plane that is spanned by the vehicle transverse direction and the vehicle vertical direction. As is clear from FIGS. 11a, b, the lever 136 can be moved, in particular pivoted, relative to the center console 10, for example, from a home position to at least one actuation position B shown in FIG. 11b. In the actuation position B, the actuating element 20, which is connected to the lever 136, for example, is actuated, thereby releasing the parking lock. In this case, the lever 136 penetrates the through opening 34, for example, at least in the actuation position B.

The aforementioned pivot axis is shown in FIG. 11b and identified therein by 138. As is particularly clear from FIG. 11b, the lever 136 comprises a first longitudinal region 140 and a second longitudinal region 142. The pivot axis 138 is located here between the longitudinal regions 140 and 142. The longitudinal region 142 is associated here with a recess 144 configured as an indentation, for example. When a force, in particular a pressing force, acting in the direction of the center console 10, is exerted on the longitudinal region 142, for example, the lever 136 is thus pivoted somewhat around the pivot axis 138 relative to the center console 10 out of its home position into a gripping position, shown in FIG. 11a. The pressing force is exerted on the longitudinal region 142, for example, by a person pressing with his/her thumb into the recess 144 and thereby on the longitudinal region 142. In the gripping position, the person can grip or grasp the longitudinal region 140 with his/her hand and pivot the lever 136 into the actuation position, thereby pulling on the actuating element 20 and deactivating the parking lock. In other words, the lever 136 is released by applying thumb pressure to the indentation, so that, for example, the person can reach behind the longitudinal region 140 with his/her index and middle fingers. Using the index and middle fingers, a rotational movement of the lever 136 into the actuation position B can be effected, thereby pulling the actuating element 20 by 100 mm, for example. The parking lock is thereby deactivated. In this way, the parking lock can be deactivated without having to disassemble the center console 10. Further, in the eighth embodiment the Bowden cable 22 or the actuating element 20 can be guided into the passenger compartment 12. The through hole 34 in this case is an access which, in the eighth embodiment, is integrated into a front storage compartment 146 of the center console 10.

Finally, FIGS. 12a, b show a ninth embodiment, in which the tool 32 is likewise configured as a vehicle-fixed tool. The tool 32 here is configured as an operating element in the form of a knob 148, which is connected to the actuating element 20. In a home position shown in FIG. 12a, the knob 148 is accommodated in the corresponding through opening 34. To deactivate the parking lock, the knob 148 is pulled out of the through opening 34 and moved, in particular pulled, into an actuation position B shown in FIG. 12b. In this way, the actuating element 20 is pulled, thereby deactivating the parking lock.

In the ninth embodiment, the through opening 34 is associated, for example, with a cover element configured in particular as a lid, by means of which the through opening 34 can be closed. Once the cover element is taken out, the knob 148 can be grasped by a person, for example, and pulled by 100 mm, for example, out of the through opening 34, to thereby pull the actuating element 20 and as a result deactivate the parking lock. The knob 148 is, for example, a holder, also configured as a multifunction holder, on which objects can be held or suspended, for example. In the ninth embodiment, a fastening device not shown in the figure may be provided, by means of which the actuated actuating element 20, for example, in particular the Bowden cable 22, can be fastened in its actuated position, in particular relative to the center console 10. An inadvertent or automatic activation of the parking lock can thereby be prevented.

1-10. (canceled)

11. An actuating device for actuating an emergency release of a transmission of a motor vehicle, which transmission comprises:
a parking lock and is mechanically blocked by the parking lock when the parking lock is activated, said actuating device having at least one vehicle-fixed actuating element, by which the parking lock can be deactivated manually and mechanically, and having a tool configured as separate from the actuating element, via which the actuating element can be manually and mechanically actuated to manually deactivate the parking lock,
wherein the tool comprises at least one lever, which is held pivotably on a component that can be located in the passenger compartment of the motor vehicle, and which can be pivoted relative to the component into at least one actuation position to actuate the actuating element.

12. The actuating device according to claim 11, wherein the lever is held on the component such that the lever is pivotable about a pivot axis relative to the component.

13. The actuating device according to claim 12, wherein when the actuating device and the component are in the installed position, the pivot axis extends in the vehicle vertical direction.

14. The actuating device according to claim 12, wherein the lever has a first longitudinal region and a second longitudinal region that adjoins the first longitudinal region in the longitudinal direction of extension of the lever, wherein the pivot axis is located between the longitudinal regions in the longitudinal direction of extension of the lever.

15. The actuating device according to claim 14, wherein the component has a recess, associated with the second longitudinal region, in which recess the second longitudinal region is at least partially disposed when the lever, which is pivotable from a home position to the actuation position, is in the home position.

16. The actuating device according to claim 15, wherein when the actuating device and the component are in the installed position, the recess is open toward the passenger compartment of the motor vehicle.

17. The actuating device according to claim 11, wherein the component comprises a through opening, wherein the lever and/or the actuating element penetrate the through opening, at least when the lever is in the actuation position.

18. The actuating device according to claim 17, wherein when the actuating device and the component are in the installed position, the through opening points toward the rear in the vehicle longitudinal direction.

19. The actuating device according to claim 11, wherein the component is configured as a center console.

20. The actuating device according to claim 11, wherein the actuating element comprises a Bowden cable coupled to the lever.

21. The actuating device according to claim 12, wherein the component comprises a through opening, wherein the lever and/or the actuating element penetrate the through opening, at least when the lever is in the actuation position.

22. The actuating device according to claim 13, wherein the component comprises a through opening, wherein the lever and/or the actuating element penetrate the through opening, at least when the lever is in the actuation position.

23. The actuating device according to claim 14, wherein the component comprises a through opening, wherein the lever and/or the actuating element penetrate the through opening, at least when the lever is in the actuation position.

24. The actuating device according to claim 15, wherein the component comprises a through opening, wherein the lever and/or the actuating element penetrate the through opening, at least when the lever is in the actuation position.

25. The actuating device according to claim 16, wherein the component comprises a through opening, wherein the lever and/or the actuating element penetrate the through opening, at least when the lever is in the actuation position.

26. The actuating device according to claim 12, wherein the component is configured as a center console.

27. The actuating device according to claim 13, wherein the component is configured as a center console.

28. The actuating device according to claim 14, wherein the component is configured as a center console.

29. The actuating device according to claim 15, wherein the component is configured as a center console.

30. The actuating device according to claim 16, wherein the component is configured as a center console.
